(19) United States
(12) Patent Application Publication
(10) Pub. No.: US 2012/0026418 A1
(43) Pub. Date: Feb. 2, 2012

(54) LIQUID CRYSTAL DISPLAY APPARATUS

(76) Inventor: Kenichiro Tsuchida, Osaka (JP)

(21) Appl. No.: 13/263,211

(22) PCT Filed: Dec. 24, 2009
(86) PCT No.: PCT/JP2009/071456

§ 371 Date: Oct. 6, 2011

(30) Foreign Application Priority Data
Apr. 15, 2009 (JP) 2009-098819

(51) Int. Cl. G02F 1/1335

(52) U.S. Cl. 349/15

(57) ABSTRACT

Provided is a liquid crystal display device that enables satisfactory stereoscopic image display, free of crosstalk, even when using a liquid crystal panel provided with pixel areas including complex-shaped display sections. The liquid crystal display device of the present invention is a liquid crystal display device provided with a liquid crystal panel including a plurality of pixel areas and a parallax barrier that covers a panel surface of the liquid crystal panel, wherein each of the pixel areas includes a display section and a non-display section; the display section includes in at least part thereof a recess; the parallax barrier includes light-transmitting regions and light-blocking regions arrayed at equal distances; the light-blocking regions of the parallax barrier have projections aligned with recesses of the liquid crystal panel; and the width of the light-transmitting regions is reduced at regions at which the projections are formed.

### TECHNICAL FIELD

The present invention relates to a liquid crystal display device. More specifically, the present invention relates to a liquid crystal display device in which images can be displayed stereoscopically.

### BACKGROUND ART

Known display devices in the fields of cell phones, game devices and the like include display devices in which stereoscopic image display (3D display) under the naked eye is achieved without using any special glasses or devices. To perform 3D display under the naked eye it is necessary to send dissimilar image information to the left and right eyes simultaneously. Therefore, 3D display devices have been proposed in which a panel, called a parallax barrier, is provided on a liquid crystal panel (for instance, Patent document 1).

In a 3D display device provided with a parallax barrier, the latter partially blocks light that passes through the liquid crystal panel. The parallax barrier includes a configuration in which band-like light-transmitting regions and light-blocking regions are alternately disposed. Patent document 1 discloses a liquid crystal display device that uses a parallax barrier having uniform spacings between light-transmitting regions, in order to achieve a wide viewing angle.

The liquid crystal panel is configured in such a manner that rectangular pixel areas are disposed in the form of a matrix, such that in each pixel area, for instance, a right eye image and a left eye image are alternately displayed, for each column.

In the abovementioned parallax barrier and liquid crystal panel, the parallax barrier is disposed on the display surface side of the liquid crystal panel in such a manner that only left eye image information reaches the left eye, and only right eye image information reaches the right eye when an observer looks at the display device. As a result, the number of effective pixels in the left-right direction is halved, but there can be displayed good stereoscopic video images.

### PRIOR ART REFERENCE

### Patent Document

Patent document 1: JP 2004-287440 A

In recent years, however, pixels have become smaller as a result of ever smaller and thin profile liquid crystal display devices. Moreover, for instance TFT elements as well as spacers for keeping a constant cell thickness are disposed within pixel areas. The regions at which the TFT elements, spacers and so forth are disposed constitute light-blocking sections and are accordingly non-display sections where image display is precluded. The shape of the display section in the pixel areas is not thus the abovementioned rectangular shape, but a complex shape having a recess in part thereof.

In pixel areas including complex-shaped display regions, as described above, a parallax barrier including light-blocking regions and light-transmitting regions of uniform width may fail to cover appropriately required sites, and right eye image information and left eye image information may fail to be sufficiently separated, as described in Patent document 1. Therefore, pixels at portions where light partially fails to be blocked may become visible, depending on the view-point position, and there may occur the so-called crosstalk phenomenon wherein right eye and left eye images are mixed with each other.

The width of the parallax barrier that separates left and right images must be increased in order to reduce such crosstalk, but increasing the width of the parallax barrier entails wider light-blocking regions, which results in reduced light transmittance. It has been thus difficult to secure light transmittance while reducing crosstalk in existing parallax barriers.

### DISCLOSURE OF THE INVENTION

In the light of the above, it is an object of the present invention to provide a liquid crystal display device that enables good stereoscopic image display, free of crosstalk, even when using a liquid crystal panel provided with pixel areas including complex-shaped display sections.

The inventors conducted various studies on liquid crystal display devices that enable good stereoscopic image display, and came to focus on the shape of light-blocking regions in a parallax barrier. The inventors found that crosstalk occurs in that right eye image information and left eye image information fail to be sufficiently separated since the rectangular shapes of light-blocking regions in the parallax barrier are arranged parallelly to each other, also in a case where there is used a liquid crystal panel provided with pixel areas including complex-shaped display sections, and found that crosstalk can be prevented, while securing the necessary light transmittance, by modifying the shape of the light-blocking regions of the parallax barrier in accordance with the shape of the display sections of the pixel areas. The inventors found that the above problems could be admirably solved thereby, and arrived thus at the present invention.

Specifically, the present invention is a liquid crystal display device provided with a liquid crystal panel including a plurality of pixel areas and a parallax barrier that covers a panel surface of the liquid crystal panel, wherein each of the pixel areas includes a display section and a non-display section; the display section includes in at least part thereof a recess; the parallax barrier includes light-transmitting regions and light-blocking regions arrayed at equal distances; the light-blocking regions of the parallax barrier have projections aligned with the recesses of the liquid crystal panel; and the width of the light-transmitting regions is reduced at regions at which the projections are formed.

The liquid crystal panel is not particularly limited, but is preferably an active-matrix liquid crystal panel, since in this case crosstalk is less likely to occur between adjacent pixels. An active-matrix liquid crystal panel includes a thin film transistor array substrate (hereafter, also “TFT (thin film transistor) array substrate”), and is provided with pixel areas including the above-mentioned complex-shaped display regions. Accordingly, the present invention can be suitably used in active-matrix liquid crystal panels.

Ordinarily, active-matrix liquid crystal panels have a configuration wherein a liquid crystal layer is held between a TFT array substrate and an opposed substrate, disposed at a predetermined spacing, via alignment layers. The intensity of the electric field that is applied across pixel electrodes at respective pixel areas formed on the TFT array substrate side and common electrodes formed on the opposed substrate side is controlled to alter the alignment state of the liquid crystal at respective pixel areas. Light transmittance is modified thereby, and an image is displayed as a result.

Each pixel area has a display section including a recess at least in part thereof, and a non-display section formed in that recess. The recess is provided in order to arrange therein a TFT element, spacer or the like. With light transmittance of the pixel areas in mind, the surface area of the recesses is preferably as small as possible.

The parallax barrier partially blocks light that passes through the liquid crystal panel. The parallax barrier has a configuration in which band-like light-transmitting regions and light-blocking regions are disposed at equal distances. The light-blocking regions are formed along the direction in which the right eye pixel areas and the left eye pixel areas are arrayed, and allow switching between a light-blocking state in a state (on state) where voltage is applied and a light transmission state in a state (off state) where no voltage is applied. In the present description, the feature “equal distances” indicates that the arrangement spacing between the band-like light-transmitting regions and the light-blocking regions is completely identical, or substantially identical. More specifically, the arrangement spacing is identical in such a degree as to enable 3D display to be realized.

During 3D display, for instance, the parallax barrier is in an on-state and the light-blocking region is in a light-blocking state, as a result of which 3D display can be performed through separation of respectively dissimilar right eye images and left eye images. During 2D display, the parallax barrier is in an off-state and the light-blocking region in a light transmission state, so that 2D display can be performed as a result. Therefore, the liquid crystal display device according to the present invention is a display device that can switch easily between 2D display and 3D display.

Switching between the above-described on-state and off-state can be easily performed by configuring the parallax barrier out of a liquid crystal panel. Using such a parallax barrier allows easily switching between 2D display and 3D display.

The light-blocking regions of the parallax barrier have projections aligned with the recesses formed in respective pixel areas, such that the width of the light-transmitting regions is reduced at regions at which the projections are formed. Even if the shape of the display sections (aperture portion of the pixel) is a complex shape, the width of the light-blocking regions of the parallax barrier is increased as a result in pixel ranges where the width of an aperture portion is partly small. Crosstalk can be reduced thereby, without drops in light transmittance in the pixel areas.

The configuration of the liquid crystal display device of the present invention is not especially limited by other components as long as it essentially includes such components.

In one preferred embodiment of the liquid crystal display device having the above-described configuration, the projections and the recesses have identical length in a direction perpendicular to the projection direction of the projections. The above-described effect can be enhanced thereby.

In the present description, the term “identical” indicates that the lengths may be completely identical, or substantially identical, in such a degree so as to enable the various effects of the present invention to be brought out.

In the same way as described above, crosstalk can be reduced, without loss of light transmittance in the pixel areas, by way of the feature wherein the arrangement spacing of the projections and the arrangement spacing of the recesses are identical in the direction perpendicular to the projection direction of the projections.

In present description, the term “identical” indicates that the arrangement spacings may be completely identical, or substantially identical, in such a degree so as to enable the various effects of the present invention to be brought out.

In another preferred embodiment of the present invention, a first column in which a plurality of right eye pixel areas is disposed and a second column in which a plurality of left eye pixel areas is disposed are alternately arranged in the pixel areas; the light-blocking regions are arrayed along the column direction; and the liquid crystal panel and the parallax barrier are disposed in such a manner that a boundary between the first column and the second column coincides with a center along a direction in which the light-blocking regions are arrayed, as viewed from a normal direction of the liquid crystal panel. In other words, the center along the direction in which the light-blocking regions are arrayed is the center of the light-blocking regions in the longitudinal direction. The above configuration allows right eye images and left eye images to be reliably separated.

In the present description, “normal direction of the liquid crystal panel” denotes a normal direction of the main surface of the liquid crystal panel.

In this embodiment, right eye images and left eye image are separated more reliably, and crosstalk is reduced as a result, by arranging the liquid crystal panel and the parallax barrier in such a manner that the light-blocking sections that make up the pixel areas of the liquid crystal panel and the projections formed in the light-blocking regions of the parallax barrier are aligned along the projection direction of the projections, as viewed from the normal direction of the liquid crystal panel.

The above embodiments can be suitably combined with each other without departing from the scope of the present invention.

### Effect Of The Invention

The liquid crystal display device of the present invention allows realizing a liquid crystal display device having excellent 3D display characteristics and that allows suppressing crosstalk between right eye images and left eye images, while securing a necessary light transmittance, even when using a liquid crystal panel provided with pixel areas including complex-shaped display sections.

### BRIEF DESCRIPTION OF THE DRAWINGS

FIG. 1(a) is a cross-sectional schematic diagram illustrating the configuration of a display device of the present embodiment, and FIG. 1(b) is a plan-view schematic diagram of an enlarged portion of the display device;

FIG. 2(a) is a plan-view schematic diagram of an enlarged portion of pixel areas of a liquid crystal panel;

FIG. 2(b) is a plan-view schematic diagram of an enlarged portion of a parallax barrier;

FIG. 3(a) is a cross-sectional schematic diagram along line A1-A2 in FIG. 1(b), and FIG. 3(b) is a cross-sectional schematic diagram along line B1-B2 in FIG. 1(b);

FIG. 4 is a plan-view schematic diagram illustrating another example according to the present embodiment, wherein FIG. 4(a) illustrates an example of dissimilar shapes of display sections in pixel areas, and FIG. 4(b) illustrates a parallax barrier corresponding to the pixel areas illustrated in FIG. 4(a);

FIG. 5(a) is a plan-view schematic diagram illustrating the configuration of a display device according to Comparative embodiment 1, and FIG. 5(b) is a plan-view schematic diagram of a parallax barrier 50; and

FIG. 6 is a cross-sectional schematic diagram of the display device according to Comparative embodiment 1 along line B1-B2 illustrated in FIG. 5(a).

### MODES FOR CARRYING OUT THE INVENTION

The present invention is explained in more detail below based on embodiments. However, the present invention is not limited to these embodiments alone.

### Embodiment 1

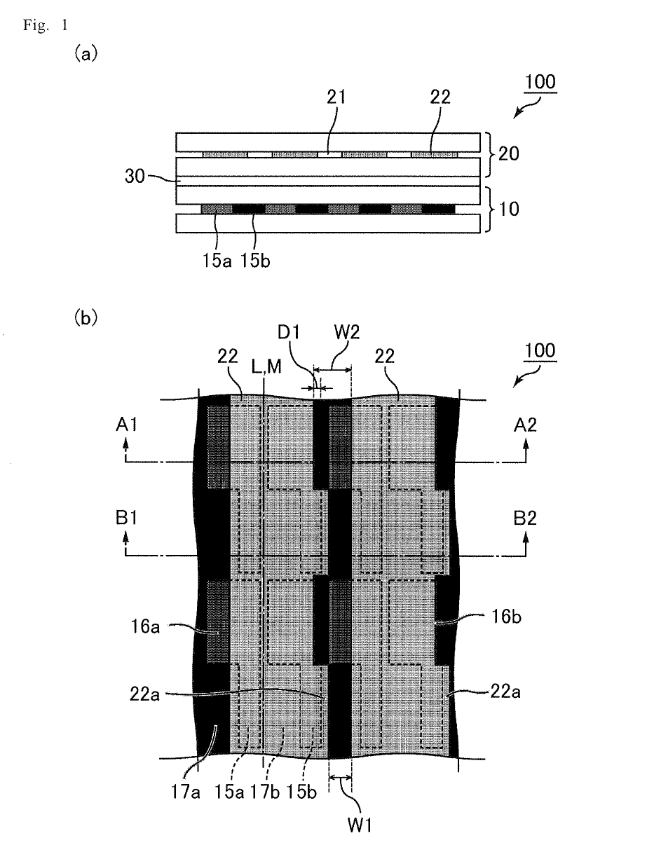

FIG. 1(a) is a cross-sectional schematic diagram illustrating the configuration of a display device according to the present embodiment; and FIG. 1(b) is a plan-view schematic diagram of an enlarged portion of the display device. In FIG. 1(a), a display device 100 has a configuration wherein a liquid crystal panel 10 and a parallax barrier 20 are bonded to each other by way of an adhesive 30. The parallax barrier 20 is disposed so as to cover the entire surface of the rear face side of the liquid crystal panel 10. The adhesive 30 comprises a transparent resin that does not lose transparency.

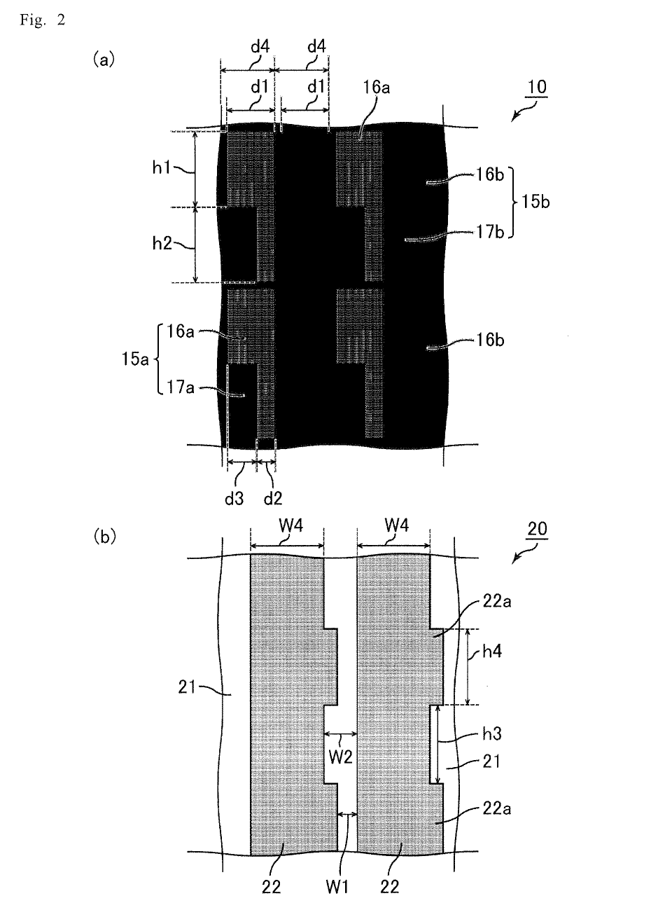

The liquid crystal panel 10 and the parallax barrier 20 are disposed as illustrated in FIG. 1(b). The liquid crystal panel 10 and the parallax barrier 20 will be explained in detail with reference to FIG. 2. FIG. 2(a) is a plan-view schematic diagram of an enlarged portion of pixel areas of the liquid crystal panel 10. FIG. 2(b) is a plan-view schematic diagram of an enlarged portion of the parallax barrier 20. As illustrated in FIG. 2(a), a plurality of rectangular pixel areas is formed in the liquid crystal panel 10. A first column in which a plurality of right eye pixel areas 15a is disposed is alternately arranged with a second column in which a plurality of left eye pixel areas 15b is disposed.

Each pixel area 15a, 15b has a respective display section 16a, 16b, part of which is shaped as a cutout in which a recess is formed, such that a respective non-display section 17a, 17b is formed in each recess. The display sections 16a, 16b are regions at which image display is performed. Although not shown in the figures, for instance a TFT element or a spacer for keeping a constant cell thickness is disposed at the non-display sections 17a, 17b.

The display sections 16a, 16b have a wide-aperture portion (width d1, length h1) and a narrow-aperture portion (width d2, length h2). The widths satisfy the relationship d2=d1−d3, d2<d1, wherein d3 denotes the width of the non-display sections 17a, 17b.

As illustrated in FIG. 2(b), the parallax barrier 20 includes band-like light-transmitting regions 21 and light-blocking regions 22 that are disposed at equal intervals, such that the light-blocking regions 22 are arrayed along the first and second column directions. The light-blocking regions 22 have projections 22a at positions aligned with the recesses of the pixel areas 15a, 15b. A width W1 of the light-transmitting regions 21 at regions at which the projections 22a are formed is narrower than a width W2 of the light-transmitting regions 21 at regions at which the projections 22a are not formed.

The projections 22a are formed in such a manner that a length h4 of the projections 22a in a direction perpendicular to the projection direction is identical to the length h2 of the recesses in the direction, formed in the pixel areas 15a, 15b.

The projections 22a are disposed in such a manner that the arrangement spacing of the projections 22a and the arrangement spacing of the recesses are identical, viewed in a direction perpendicular to the projection direction of the projections 22a, so that there holds the relationship h1+h2=h3+h4 in FIGS. 2(a) and 2(b).

The liquid crystal panel 10 and the parallax barrier 20 are disposed in such a manner that a boundary L between a first column comprising the pixels 16a and a second column comprising the pixels 16b overlaps with a center M along the direction in which the light-blocking regions 22 are arrayed, as illustrated in FIG. 1(b), as viewed from a normal direction of the liquid crystal panel 10.

Also, the liquid crystal panel 10 and the parallax barrier 20 are disposed in such a manner that, as illustrated in FIG. 1(b), the non-display sections 17a, 17b that make up the pixel areas 15a, 15b and the projections 22a formed in the light-blocking regions 22 are aligned along the projection direction of the projections 22a, as viewed from a normal direction of the liquid crystal panel 10.

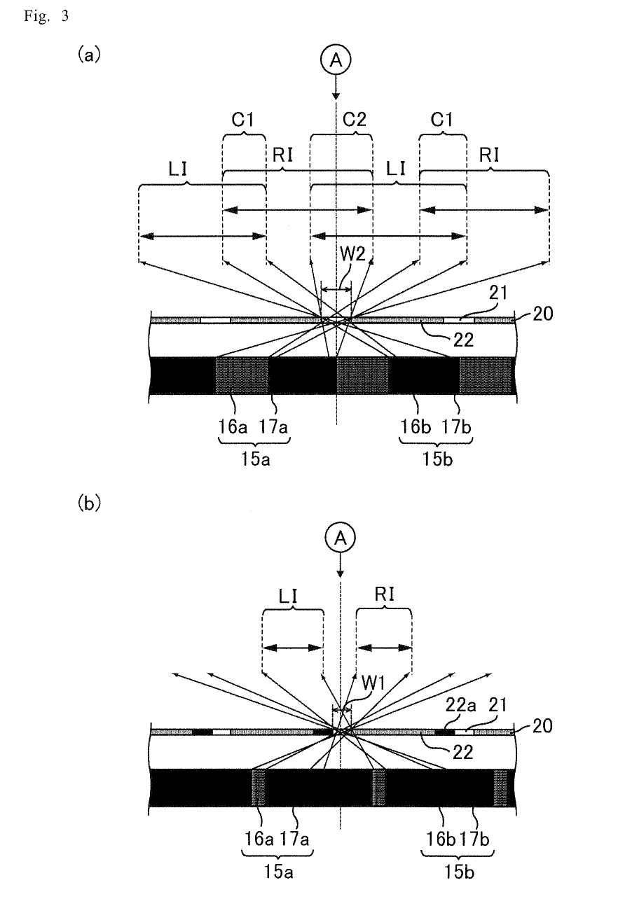

An explanation follows next on image display in the liquid crystal display device 100 configured as described above. FIG. 3(a) is a cross-sectional schematic diagram along line A1-A2 in FIG. 1(b), and FIG. 3(b) is a cross-sectional schematic diagram along line B1-B2 in FIG. 1(b).

In FIG. 3(a), the width of the display sections 16a, 16b in the pixel areas 15a, 15b is large, and the width W2 of the light-transmitting regions 21 of the parallax barrier 20 is wider than the width W1 of the regions at which the projections 22a are formed. As a result, an image RI from the right eye pixels 15a and an image LI from the left eye pixels 15b overlap partially with each other as viewed by an observer from view-point A, whereby the crosstalk C1 and crosstalk C2 are generated. In particular, the crosstalk C2 generated in the vicinity of view-point A is wider than the crosstalk C1 generated at a position spaced apart from view-point A.

In FIG. 3(b), by contrast, the widths of the display sections 16a, 16b are narrow, and the projections 22a are formed in the parallax barrier 20. Therefore, the width W1 of the light-transmitting regions 21 is smaller than the abovementioned width W2. Regions of crosstalk generation can be reduced as a result.

As illustrated in FIG. 3(b), the light-transmitting regions 21 of the parallax barrier 20 narrow down only at portions where the non-display sections 17a, 17b are present, i.e. only at regions not involved in display. Therefore, the light-transmitting regions 21 do not affect the light transmittance of the pixel areas 15a, 15b.

As described above, the present embodiment allows for design that combines crosstalk reduction and preservation of light transmittance.

The display device according to the present embodiment will be explained below based on a specific example.

### Example 1

A 3.8-type liquid crystal panel was used as the liquid crystal panel 10. The pitch d4 of the pixel areas in FIG. 2(a) was set to 103.5 μm, the width d1 of the aperture of the display sections 16a, 16b was set to 90 μm, the width d2 was set to 35 μm, the lengths h1 and h2 were set to 150 μm, and the width d3 of the non-display sections 17a, 17b was set to 55 μm.

The width W1 of the light-transmitting regions 21 of the parallax barrier 20 was set to 35 μm, and the width W2 of the light-transmitting regions 21 was set to 69 μm. The width W4 of the light-blocking regions 22 was set to 138 μm.

As illustrated in FIGS. 3(a) and 3(b), a view-point A can be envisaged such that an image RI generated by the right eye pixel areas 15a and an image LI generated by the left eye pixel areas 15b can be seen, through the light-transmitting regions 21 of the parallax barrier 20.

As illustrated in FIG. 1(b), the surface area of the image RI generated in the right eye pixel areas 15a is 8325−150×D1, from h1×{W2−(d4−d1)−D1}. The surface area of the image LI generated in the left eye pixel areas 15b is 150×D1. The crosstalk C2 generated in the present example is (150×D1)/8325, wherein the crosstalk C2 is defined as the proportion of the reverse-view image surface area with respect to the total image surface area.

For instance, crosstalk is 0.180 in a case where the width D1 of the left eye pixel areas 15b that jut beyond the light-transmitting regions 21 of the parallax barrier 20 is 10 μm. This value corresponds to about 59% in Comparative example 1 below. Therefore, it became apparent that the present example succeeds in reducing crosstalk.

In the above explanation, the shape of the pixel areas is rectangular, but the present invention is not limited thereto, and the pixel areas may have a square shape. In the above explanation, one recess was formed in each pixel area, but the recess may be a plurality thereof, and the sites at which the recesses are formed are not particularly limited either. That is, the effect of the present invention can be brought out by appropriately modifying the parallax barrier to a shape according to the configuration of the present invention depending on the shape of the display section of the pixel areas.

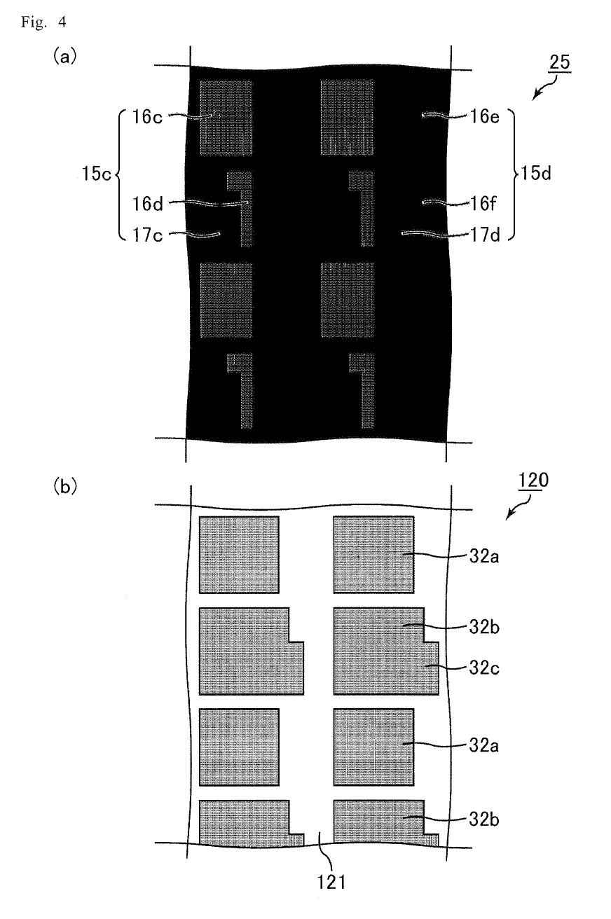

FIG. 4 is a plan-view schematic diagram illustrating another example of the present embodiment. FIG. 4(a) illustrates an example of the pixel areas 15c, 15d having different shapes from those of the pixel areas 15a, 15b illustrated in FIG. 2(a). FIG. 4(b) illustrates a parallax barrier 120 corresponding to the pixel areas 15c, 15d illustrated in FIG. 4(a).

As illustrated in FIG. 4(a), in a liquid crystal panel 25, display sections 16c, 16d having two mutually dissimilar shapes, and a non-display section 17c corresponding to the display sections 16c, 16d, are formed in one pixel area 15c for the right eye, while in one pixel area 15d for the left eye there are formed display sections 16e, 16f having two mutually dissimilar shapes, and a non-display section 17d corresponding to the display sections 16e, 16f.

As illustrated in FIG. 4(b), light-blocking regions 32a, 32b corresponding to the shape of the pixel areas 15c, 15d are formed in the parallax barrier 120, and a projection 32c is formed in each light-blocking region 32b.

A display device having a configuration such as the above-described one allows for design that combines crosstalk reduction and preservation of light transmittance.

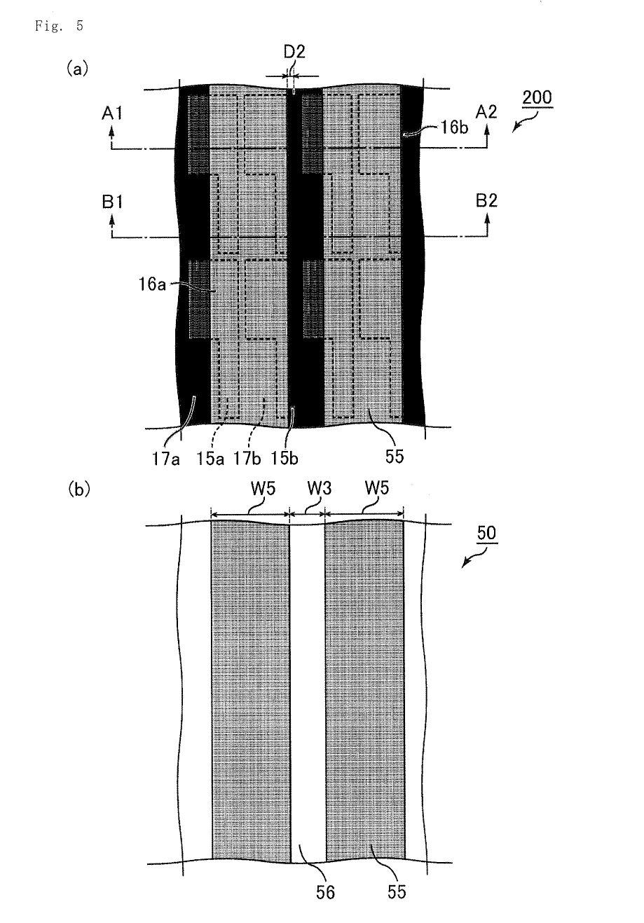

A liquid crystal display device according to Comparative embodiment 1 will be explained next with respect to FIG. 5. Features identical to those of the liquid crystal display device illustrated in FIG. 1 to FIG. 3 will be denoted with the same reference numerals, and an explanation thereof will be omitted.

### Comparative Embodiment 1

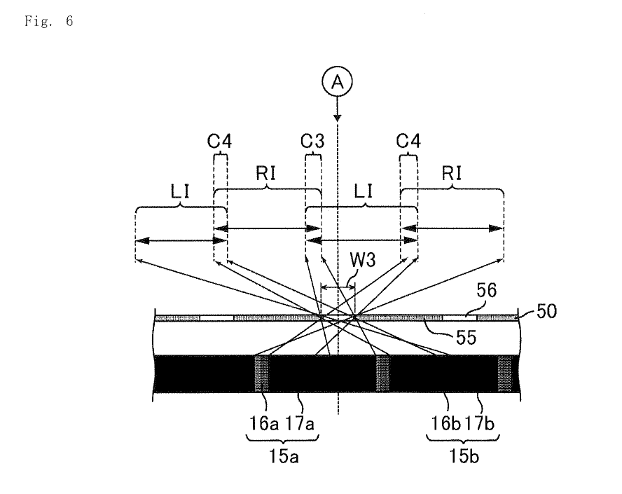

FIG. 5(a) is a plan-view schematic diagram illustrating the configuration of a display device according to the present comparative embodiment. FIG. 5(b) is a plan-view schematic diagram of a parallax barrier. FIG. 6 is a cross-sectional schematic diagram along line B1-B2 in FIG. 5(a).

As illustrated in FIG. 5(a) and FIG. 5(b), the present comparative embodiment differs from Embodiment 1 above as regards the configuration of a parallax barrier 50. Specifically, the parallax barrier 50 includes a configuration wherein band-like light-blocking regions 55 and light-transmitting regions 56, having all a uniform width, are alternately arrayed. Therefore, the light-transmitting regions 56 as well have all uniform width.

Image display in the liquid crystal display device 200 having the above configuration has the same features as in Embodiment 1 at regions of large width of the display sections 16a, 16b in the pixel areas 15a, 15b. Therefore, the cross-sectional schematic diagram along line A1-A2 is identical to that of FIG. 3(a) above. However, the small-width region of the display sections 16a, 16b is different from that of Embodiment 1.

As illustrated in FIG. 6, the width W3 of the light-transmitting regions 56 of the parallax barrier 50 is greater than the width W2 of the light-transmitting regions 21 in Embodiment 1. Therefore, crosstalk is generated in the same way as in the region along line A1-A2.

The light-blocking regions 55 of the parallax barrier 50 have all uniform width. Therefore, the aperture portion of the pixel areas becomes narrower and a light transmittance drops, at regions along line A1-A2, upon reduction of the width of the light-transmitting regions 56 of the parallax barrier 50 in order to reduce crosstalk at the region indicated by B1-B2. The display device 200 according to the present comparative embodiment, thus, does not allow for design that combines preservation of light transmittance and crosstalk reduction.

The display device according to the present comparative embodiment will be explained below on the basis of specific examples.

### Comparative Example 1

The occurrence of crosstalk was measured in the same way as in Example 1 using the same liquid crystal panel 10 as in Example 1. Herein, however, the width W3 of the light-blocking regions 55 of the parallax barrier 50 was a uniform width set to 69 μm.

As illustrated in FIG. 5, the surface area of the image generated at the right eye pixel areas 15a was 8325-150×D2, wherein D2 denotes the width of the left eye pixel areas 15b that jut beyond the light-transmitting regions 55 of the parallax barrier 50, and the surface area of The image generated at the left eye pixel areas 15b was 300×D2, which is twice the surface area of the image generated by the left eye pixel areas 15b in Example 1. Herein, crosstalk was 300×D2/(8325+150×D2).

Accordingly, crosstalk C3 is 0.305 when the width D2 is 10 μm. This value corresponds to 1.69 times the crosstalk C2 in Example 1.

The above embodiments can be suitably combined with each other without departing from the scope of the present invention.

The present application claims priority to Patent Application No. 2009-098819 filed in Japan on Apr. 15, 2009 under the Paris Convention and provisions of national law in a designated State, the entire contents of which are hereby incorporated by reference.

### EXPLANATION OF REFERENCE NUMERALS

10, 25 liquid crystal panel
15a to 15d pixel areas
16a, 16b, 16c, 16d, 16e, 16f display section
17a, 17b, 17c, 17d non-display section
20, 50, 120 parallax barrier
21, 56 light-transmitting region
22, 55 light-blocking region
22a projection
30 adhesive
32a, 32b light-blocking region
32c projection of light-blocking region
100, 200 display device
d1, d2 width of aperture
h1, h2 length of aperture
d3 width of non-display section
W1 to W3 width of light-transmitting region
W4, W5 width of light-blocking region
D1, D2 width
C1 to C4 crosstalk

1. A liquid crystal display device provided with a liquid crystal panel including a plurality of pixel areas and a parallax barrier that covers a panel surface of the liquid crystal panel, wherein
each of the pixel areas includes a display section and a non-display section; the display section includes in at least part thereof a recess;
the parallax barrier includes light-transmitting regions and light-blocking regions arrayed at equal distances,
the light-blocking regions of the parallax barrier have projections aligned with recesses of the liquid crystal panel, and
the width of the light-transmitting regions is reduced at regions at which the projections are formed.

2. The liquid crystal display device according to claim 1, wherein the projections and the recesses have identical length in a direction perpendicular to a projection direction of the projections.

3. The liquid crystal display device according to claim 1, wherein an arrangement spacing of the projections and an arrangement spacing of the recesses are identical in the direction that is perpendicular to the projection direction of the projections.

4. The liquid crystal display device according to claim 1, wherein
a first column in which a plurality of right eye pixel areas are disposed and a second column in which a plurality of left eye pixel areas are disposed are alternately arranged in the pixel areas,
the light-blocking regions are arrayed along the column direction, and
the liquid crystal panel and the parallax barrier are disposed such that a boundary between the first column and the second column coincides with a center along a direction in which the light-blocking regions are arrayed, as viewed from a normal direction of the liquid crystal panel.

5. The liquid crystal display device according to claim 4, wherein the liquid crystal panel and the parallax barrier are disposed such that the light-blocking sections that make up the pixel areas of the liquid crystal panel and the projections formed in the light-blocking regions of the parallax barrier are aligned along the projection direction of the projections, as viewed from the normal direction of the liquid crystal panel.
